(19) United States
(12) Patent Application Publication
(10) Pub. No.: US 2023/0048451 A1
(43) Pub. Date: Feb. 16, 2023

(54) SENDING OR RECEIVING A MESSAGE WITH A SUBJECT IN A MESSAGING APPLICATION

(71) Applicant: Sarath KAKUMANU, Chennai (IN)

(72) Inventor: Sarath KAKUMANU, Chennai (IN)

(21) Appl. No.: 17/789,237

(22) PCT Filed: Dec. 26, 2020
(86) PCT No.: PCT/IN2020/051055

§ 371 Date: Jun. 27, 2022

(30) Foreign Application Priority Data
Dec. 26, 2019 (IN) 201941053902

(51) Int. Cl. H04L 51/216; H04L 51/226

(52) U.S. Cl. CPC H04L 51/216; H04L 51/226

(57) ABSTRACT

A system and method for sending and receiving messages with a ‘subject’ in a structured messaging application; thereby achieving the objective of presenting the messages within the message folders for the users to easily classify the messages based on the ‘subject’. The ‘message subject module’ configured in association with a structured messaging application for searching the existing ‘subject’s in an alphabetically arranged database or allowing the user to use the existing ‘subject’ or create a new ‘subject’ while sending a new message. The ‘message subject module’ enables a user to send a message with a ‘subject’ to another individual user or group. It enables the receivers to get the message with a ‘subject’. It also gives options for the group members to initiate a conversation under the single ‘subject’ for everyone to understand the topic of discussion without any confusion.

### TECHNICAL FIELD

The present invention relates to information technology and computer applications in general, and more particularly to messaging applications for mobile communication devices which can be accessed from all types of communication devices like Smart phones, Desktop Computers, Laptop Computers and Digital Tablets.

### BACKGROUND OF THE INVENTION

Mobile communication devices, such as Mobile phones, iPhones, Android devices, are increasingly powerful and the sources of potential incoming messages are increasingly more varied. As a result, such mobile communication devices are being designed and built to permit users to accept various different heterogeneous messages.

Thus a system and approach to handle the individual or group messages in a user friendly and convenient mechanism by proposing the message ‘subject’ to the messaging application is needed. The ‘subject’ can be optional in messaging application. The user can also send the message to another contact or groups without a ‘subject’. But the messages sent with ‘subjects’ can be easily traced by its ‘subject’ and it also makes sense in the group or individual conversation, thereby bringing in a new paradigm in the messaging applications industry by addressing certain key challenges in the existing messaging application tools, such as, WhatsApp, Facebook Messenger, Google Hangout, WeChat, Telegram, Signal, IMO, Hike and so on.

Over-the-top (OTT) mobile messaging services and messaging applications, such as WhatsApp and Apple's iMessage, enable mobile messaging via an internet connection. Usage of OTT mobile messaging has already surpassed the usage of SMS texting, largely due to the increasing use of mobile phones that have uninterrupted internet access. Other examples of OTT mobile messaging include WeChat®, Facebook® Messenger, Skype®, Kik™, GroupMe®, Slack, and Snapchat®. Desktop and laptop computers, computer notebooks, and tablet computers also run mobile messaging applications. Such conventional messaging services offer various kinds of messaging options like plain text messages, photo-based messages, messages with video or adding any kind of documents with the messages.

With the advent of modern mobile communication networks, messaging applications have gained a lot of popularity and hence reached wide adoption. Whether an individual, groups or huge organizations—they generate a large number of messages and therefore the users struggle to process and filter this sort of huge amount of information, potentially missing relevant information due to this information overload.

However, such conventional mobile messaging services do not have an option to send messages with ‘subject’s or apply filters/masks to locate specific messages with a common ‘subject’. In such instances, the sender may have to struggle to locate the specific message. It also fills up the application with too many messages displayed in a chaotic way which leads to unintended confusion in the communication. For example, if anyone looks at the string of messages exchanged within the group in the above-quoted communication tools, they can understand this confusion. We can't figure out the common ‘subject’ that connects all these messages.

The unique way of communication in the structured messaging format with ‘subject’ above the message is a unique, first-of-its-kind in the world. So, when a user has received messages under many ‘subjects’, and the user wants to trace a particular message with his/her contact or messages of any specific ‘subject,’ it will be easy for them to trace the messages based on the ‘subject’ of the message sent or received or replied or reminded.

Similarly, when a message is sent to a group or to an individual, it can be sent with a ‘subject’. All the individuals in the group can send messages with a ‘subject’. When other members in the group replies or comment or send clarification or add a note, send a reminder or edit a message on the ‘subject’ initiated by the first sender of the message. The complete string of conversation will be tagged under a single ‘subject.’

Based on the foregoing, there is a need for an improved structured messaging application for sending messages with ‘subject’ to individuals or groups in a messaging application which introduces a new and user-friendly messaging application paradigm for adding a new ‘subject’ or using the existing ‘subjects’ while sending a message for structured classification and representation of messages to the user on his/her communication device (Desktop/Laptop Computers, Digital Tablets and Mobile Phones).

### SUMMARY OF THE INVENTION

The following summary is provided to facilitate an understanding of some of the innovative features unique to the disclosed embodiment and is not intended to be a full description.

It is, therefore, one aspect of the disclosed embodiments to provide an improved structured messaging application for sending messages with ‘subject’ to individuals or group by an individual or group in a messaging application by adding a new ‘subject’ or using one of the existing ‘subjects’ irrespective of the devices like Desktop/Laptop Computer, Digital Tablets and Mobile Phones etc.

It is another aspect of the disclosed embodiments to provide for an improved user-friendly mechanism for storing the entire existing ‘subjects’ in a database in a messaging application.

It is further an aspect of the disclosed embodiments to provide an improved graphical interface above the message box to add a new ‘subject’ in a messaging application.

It is further an aspect of the disclosed embodiments to provide an improved system and method for sending messages to individuals and groups in a messaging application, thereby achieving a structured way of categorizing the messages in a messaging application.

One more aspect of the disclosed embodiments is to provide an option for the users to forward, share the messages with a subject. In the same way, the user can also receive the forward or shared messages with a ‘subject’.

The aforementioned aspects and other objectives and advantages can now be achieved as described herein. A system and method for sending messages with ‘subject’ to individuals and groups and receiving messages with ‘subjects’ from an individual or group in a messaging application can be done by adding a new ‘subject’ or using the existing ‘subject’ while replying thereby achieving clarity in communication with respect to a message, is disclosed herein. The message ‘subject’ module configured in association with a structured messaging application for applying filters/mask with respect to easily locating a message in a message folder. The message ‘subject’ module enables a sender to select a preferred ‘subject’ from the list of existing ‘subjects’ or allowing the sender to create a new ‘subject’ within a messaging folder to whom he/she would like to send a message and avoid the chaotic display of messages without the ‘subject’. A messaging server is required for receiving, processing and sending messages with ‘subjects’ from the messaging application to the intended contacts.

The message ‘subject’ module also alerts the recipients about the ‘subject’ of the message which makes the recipient aware of the intended message ‘subject’ an d avoids confusion among the individual users or group members. By offering a simplified mechanism to locate the messages by ‘subject’ (s), the message ‘subject’ module therefore reduces the burden of locating/filtering the various kinds of messages sent and received on different period. For example, in a marketing group of an entity, if a member in the group needs to send a message to associates relating to a specific topic, the user may select the topic from the existing ‘subjects’ or he/she can easily create a new ‘subject’ to send messages to the group members. And the string of messages exchanged at various dates and time between the same group members will be linked with a ‘single subject.’

The structured messaging application also permits the users to add any number of new ‘subjects’ and all these ‘subjects’ will be made available in the database for the users whenever they would like to refer while writing a new message.

When one of the recipients in the group replies to the message with a ‘subject’, the string of replies, clarification request, edited messages and notes will appear under the common ‘subject’ for any of the group members to easily understand the messages received.

The sender can post a message without adding a ‘subject’ in the message. The message posted to his contact or to a group will go without a ‘subject’ for the message. The ‘subject’ is not mandatory. At the same time, messages with ‘subject’ will give better clarity for the users.

From one individual to another individual, it will become easy for both the individuals to clearly understand under what ‘subject’ the message has been sent, received and replied and also reminded.

### BRIEF DESCRIPTION OF THE DRAWINGS

FIGS. 1-4 illustrate a graphical representation of a sequence of screenshots representing “Conversation between two individuals on a same subject” of the structured messaging application with message subject module, in accordance with the disclosed embodiments; and

FIG. 5 illustrates a graphical representation of a screenshot representing “A User Receives Messages on Different Subjects from his/her Contact” of the structured messaging application with message subject module, in accordance with the disclosed embodiments; and

FIG. 6 illustrates a graphical representation of a screenshot representing “The Appearance of Different Messages with Different Subjects from the Multiple Senders in a Group Message Folder” of the structured messaging application with message subject module, in accordance with the disclosed embodiments; and

FIG. 7-9 illustrate a graphical representation of a screenshot representing “Group Conversation on a Single Subject” of the structured messaging application with message subject module, in accordance with the disclosed embodiments; and

FIG. 10 illustrates a schematic of sending or receiving a message with a ‘subject’ in a messaging application, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein;

rather, these embodiments are provided so that this disclosure will be thorough and complete, and will fully convey the scope of the invention to those skilled in the art. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of different features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The attached pictorial documents illustrate a graphical representation of the structured messaging application for message ‘subject’ module for achieving clarity in communication while sending or receiving a message from individuals or group members, in accordance with the disclosed embodiments. The message ‘subject’ module configured in association with a structured messaging application for easily storing and retrieving a specific message based on its ‘subject’. Sending message with a ‘subject’ enables a sender to select a preferred ‘subject’ from the database or create a new ‘subject’ to avoid the confusion, as illustrated in the documents with its figures.

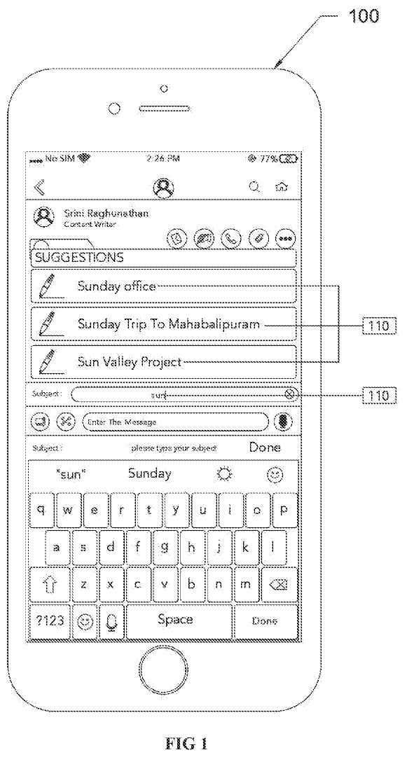

FIG. 1-4 illustrate a graphical representation of various screens 100-400 illustrating mobile version of the screens connected to ‘conversation between two individuals on a same subject.’

The structured messaging application also permits the users to get an alphabetically arranged list of ‘subjects’ for reference by searching the required alphabet from the message folder, as illustrated in FIG. 1.

FIG. 1 illustrates a graphical representation of the structured mobile application (100) connected to ‘Conversation between two individuals on a same subject’. 110 shows the ‘portion of subject’ searched by the user, 120 shows the message ‘subject’ list.

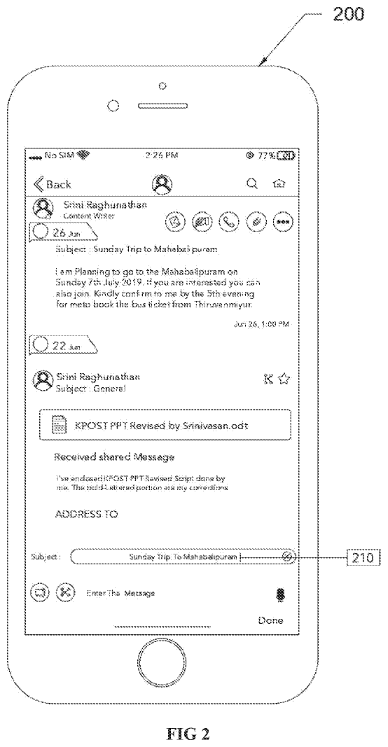

FIG. 2 illustrates a graphical representation of the structured mobile application (200), 210 shows the user selected the subject in the searching list.

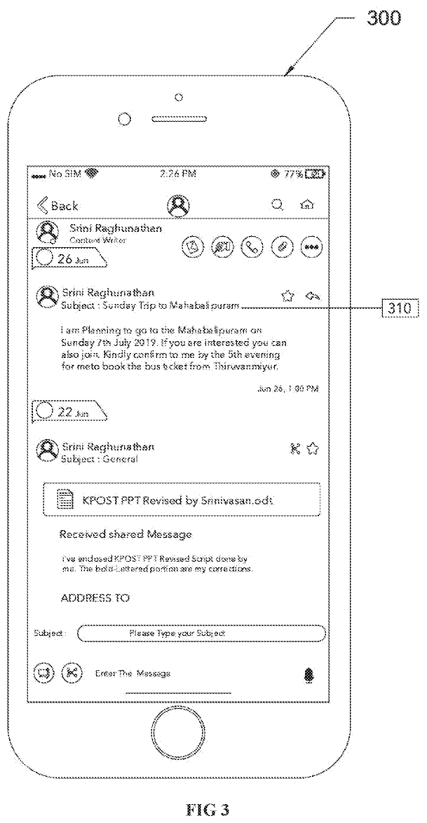

FIG. 3 illustrates a graphical representation of the structured mobile application (300), 310 shows the shows the appearance of a recently sent message with a ‘subject’.

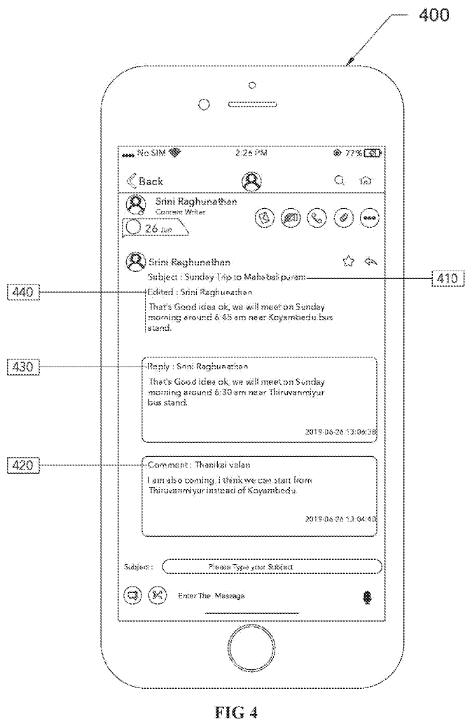

FIG. 4 illustrates a graphical representation of the structured mobile application (400), 410 represents highlights the ‘Message Subject’ is the latest reply message, 420 represents the latest message (comment) sent by the user, (430) represents the reply message, (440) represents the Edited Message part.

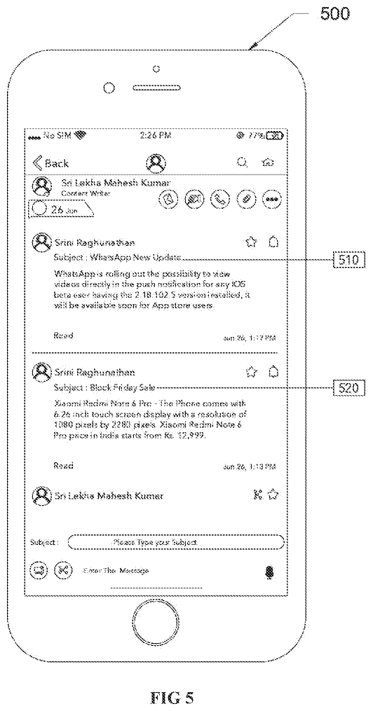

FIG. 5 illustrates, (mobile version) is a graphical representation of a scenario ‘A User receives messages on different subjects from his/her contact.’ (500), 510 shows the message the user received on one subject, 520 shows the user received on another ‘subject’.

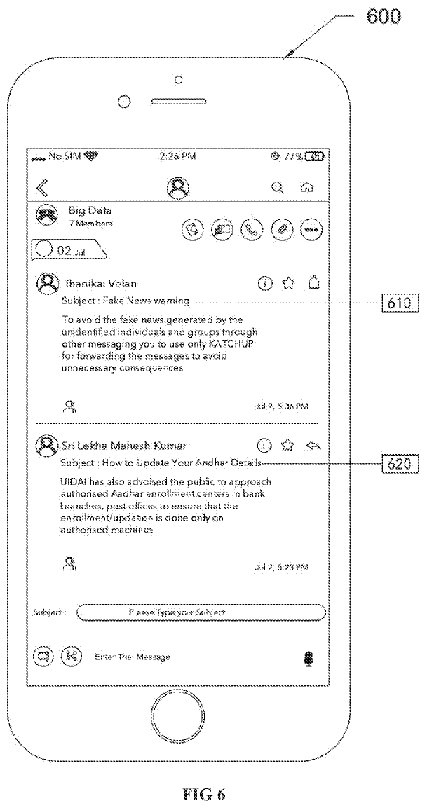

FIG. 6 illustrates, (mobile version) is a graphical representation of a scenario ‘different messages with different subjects in Group message folder(600)’, 610 shows the message the user received on one ‘subject’ and 620 shows another message with a different ‘subject’ in accordance with the disclosed embodiments.

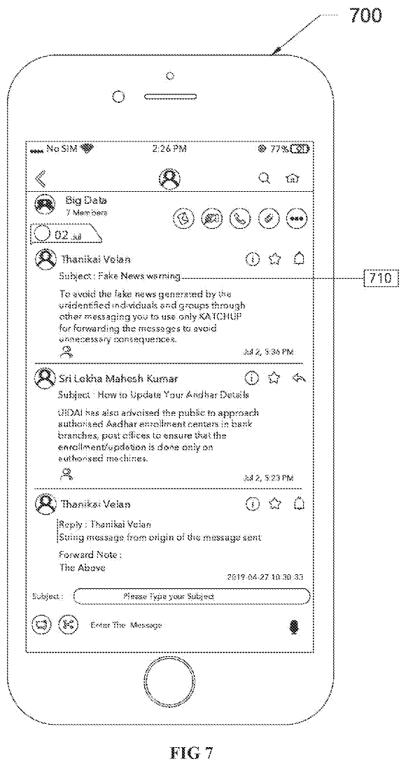

FIG. 7 illustrates, (mobile version) is a graphical representation of a scenario ‘Group conversation on a single subject.’(700), 710 highlights one of messages sent by the group member with ‘subject’.

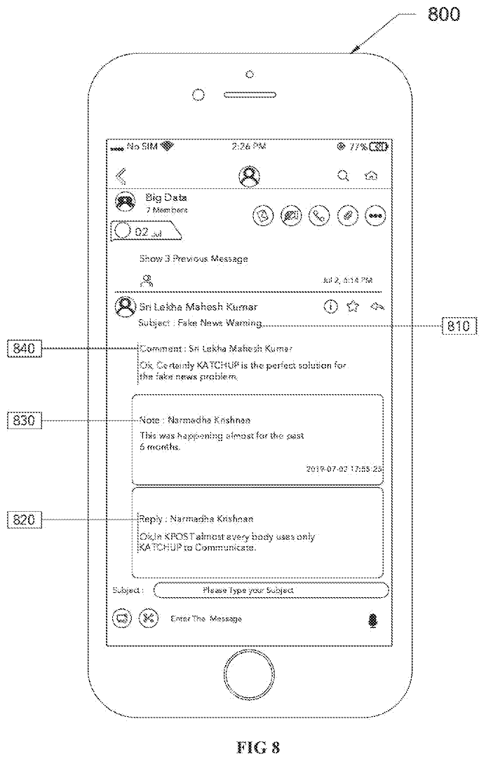

FIG. 8 illustrates a graphical representation of the ‘Group Conversation on a Single Subject’(800), 810 highlights the ‘Message Subject’, 820 is Reply message with same ‘subject’, 830 shows the Note message with same ‘subject’, 840 represents the Comment with same ‘subject’, 940 shows the Clarify with same ‘subject’.

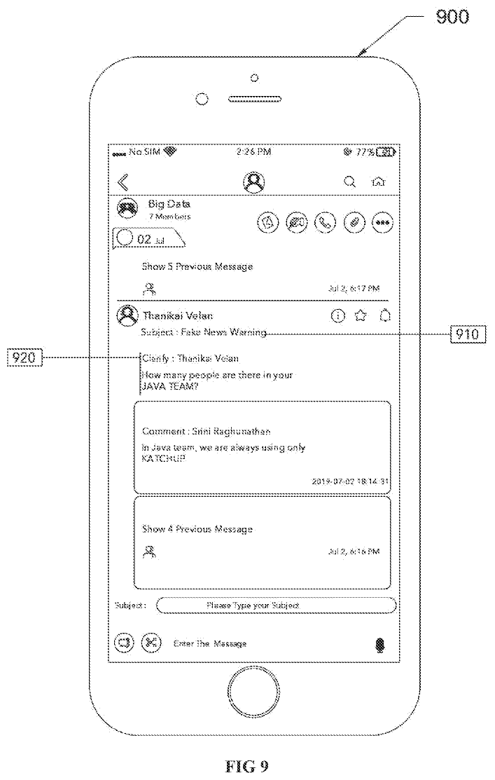

FIG. 9 illustrates a graphical representation of the ‘Group Conversation on a Single Subject’ (900), 910 highlights the ‘Message Subject’, 920 shows the Clarify with same ‘subject’.

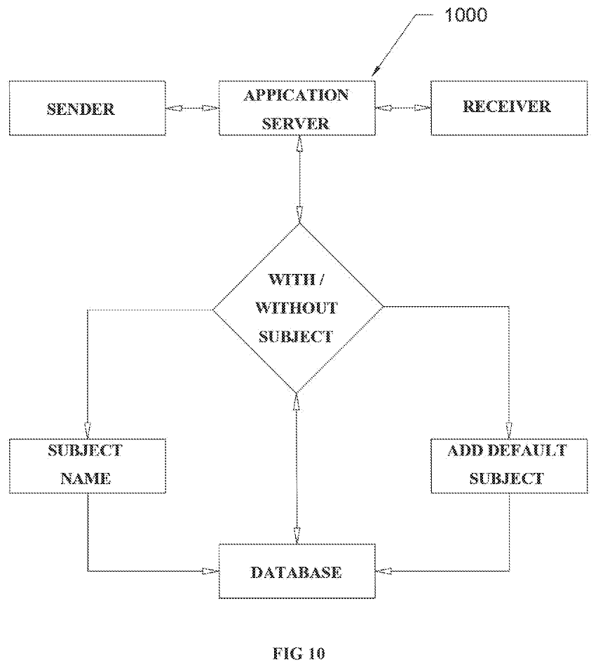

FIG. 10 illustrates a method of sending and receiving a message with a subject line in a messaging application by a first user to a second user or a group of users. The method comprises entering, by the first user, a subject line for sending a message to a second user or a group of users; and choosing the subject line and sending the message, by the first user to the second user or to the group of users. The second user or the group of users receives the message sent with the subject line, by the first user; and the second user or at least a second user of the group of users accordingly replies to the received message with a subject line from the first user.

In an embodiment, the choosing of the subject line and sending the message, by the first user to the second user or the group of users comprises searching existing ‘subjects’ and choosing one of the existing subjects from a database of a messaging application server or adding a new ‘subject’ while sending a message. In another embodiment, the second user replies to a received message, with a message having the same subject line from the message sent by the first user.

In all the embodiments herein, any number of messages with different subject lines can be sent by the first user to a second user or at least one second user of a group of users, and the string of conversation happens between the first user and the second user or between the users of a group of users on the same subject. Moreover, the users of the communication application are allowed to save or delete the messages sent or received that appears with a subject.

In another embodiment, system of sending or receiving a message with a ‘subject’ line comprises a user communication device communicably coupled to an application server, said application server being configured to receive inputs from the user's communication device to synchronize the data of the users' communication device with the server, a communication module (message subject module) configured in association with a structured messaging application for creating new messages, displaying the existing messages from the database of the messaging application and a message application server configured to receive, process and send the ‘subject’ of the message request from the messaging application, displaying the results for ‘subject-wise’ search conducted by the users from the individual or group folders of the messaging application. The first user from his user communication device chooses a subject line and sends a message to the user communication device of a second user or the group of users by searching existing ‘subjects’ and choosing one of the existing subjects from a database of a messaging application server or adding a new ‘subject’ while sending a message.

The second user while replying to the message received from the first user with a subject line, will be tagged with the same subject. The system is configured to tag the same subject of the first user in the conversation string each time—the messages exchanged between two individual users or group of users over a period of time.

In a further embodiment, messaging application is configured to send several messages with different subject lines, receive, any number of messages with different subject lines, and reply by the second user to a received message with the same subject line sent by the first user. The system is further configured to enable the user to conduct ‘subject-wise’ search to easily sort the entire sequence of communication happening in a messaging application between the individuals or group members over a period of time that is linked to a single ‘subject’, and the system is further configured to enable the first users (senders) to send a reminder, edit, add notes to the messages sent with a ‘subject’ line, and the second users (receivers) to send reply, comment and seek clarification for the messages received with a ‘subject’ line from the first user, and enable both the first users (senders) and second users (receivers) to translate, transfer, forward, copy, share, save and delete the messages with a ‘subject’ line they receive or sent.

It will be appreciated that variations of the above-disclosed and other features and functions, or alternatives thereof, may be desirably combined into many other different systems or applications. Also, unforeseen or unanticipated alternatives, modifications, variations or improvements therein may be subsequently made by those skilled in the art which are also intended to be encompassed by the following claims.

I claim:

1. A method of sending and receiving a message with a subject line by a user communication device, between a plurality of users or a group of users, the method comprising:
searching, by a first user, a subject line for sending a message to a second user or a group of users;
choosing the subject line and sending the message, by the first user to the second user or to the group of users;
receiving, by the second user or the group of users, the message sent with the subject line, by the first user; and
replying, by the second user or at least a second user of the group of users, to the received message from the first user.

2. The method as claimed in claim 1, wherein the choosing the subject line and sending the message, by the first user to the second user or the group of users comprises searching existing ‘subjects’ and choosing one of the existing subjects from a database of a messaging application server or adding a new ‘subject’ while sending a message, and
wherein replying to the received message from the first user with a subject line, can be done by a plurality of users in the group of users.

3. The method as claimed in claim 1, further comprising replying, by the second user or at least a second user of the group of users to a received message, with a message having same subject line from the message sent by the first user.

4. The method as claimed in claim 1, further comprising sending by the first user to a second user or at least one second user of a group of users, any number of messages with different subject lines, and
replying, by the second user or at least a second user of the group of users to a received message, with a message having different subject line from the message sent by the first user.

5. The method as claimed in claim 1, wherein the first user is an individual or an individual of the group of users.

6. A system for sending and receiving a message with a subject line, between a plurality of users or a group of users, said system comprising:
a user communication device communicably coupled to an application server, the application server being configured to receive inputs from the user's communication device to synchronize the data of the user's communication device with the application server; and
a communication module operably coupled to a message application server and the user communication device,
wherein the system is configured to:
search, a subject line for sending a message to a second user or a group of users, in the user communication device of a first user;
choose the subject line and send the message, from the user communication device of the first user to the user communication device of a second user or the group of users;
receive, the message sent with the subject line, by the user communication device of the first user in the user communication device of the second user or the group of users; and
reply, to the received message from the user communication device of the first user by the user communication device of the second user or at least a second user of the group of users.

7. The system as claimed in claim 6, wherein the choosing the subject line and sending the message, from the user communication device of the first user to the user communication device of a second user or the group of users comprises searching existing ‘subjects’ and choosing one of the existing subjects from a database of a messaging application server or adding a new ‘subject’ while sending a message, and
wherein replying to the received message from the first user with a subject line, can be done by a plurality of users in the group of users.

8. The system as claimed in claim 6, wherein the user communication device of the second user or at least a second user of the group of users is configured to reply to a received message, with a message having same subject line from the message sent by the first user.

9. The system as claimed in claim 6, wherein the user communication device of the second user or at least a second user of the group of users is configured to:
receive any number of messages with different subject lines, and
reply to a received message, with a message having different subject line from the message sent by the first user.

10. The system as claimed in claim 6, wherein the first user is an individual or an individual of the group of users.

11. The system as claimed in claim 6, wherein the system is configured to enable the user to conduct ‘subject-wise’ search to easily sort the entire sequence of communication happening between the individuals or group members over a period of time that is linked to a single ‘subject’, and
the system is further configured to enable the first users (senders) to send reminder, edit, add notes to the messages sent with a ‘subject’ line; and the second users (receivers) to send reply, comment and seek clarification for the messages received with a ‘subject’ line from the first user, and enable both the first users (senders) and second users (receivers) to translate, transfer, forward, copy, save and delete the messages with a ‘subject’ line they receive or sent.

12. A computer program product for sending and receiving a message with a subject line by a user communication device, between a plurality of users or a group of users, the method comprising:
searching, by a first user, a subject line for sending a message to a second user or a group of users;
choosing the subject line and sending the message, by the first user to the second user or the group of users;
receiving, by the second user or the group of users, the message sent with the subject line, by the first user; and
replying, by the second user or at least a second user of the group of users, to the received message from the first user,
wherein the choosing the subject line and sending the message, from the user communication device of the first user to the user communication device of a second user or the group of users comprises searching existing ‘subjects’ and choosing one of the existing subjects from a database of a messaging application server or adding a new ‘subject’ while sending a message,
wherein replying to the received message from the first user with a subject line, can be done by a plurality of users in the group of users,
wherein the user communication device of the second user or at least a second user of the group of users is configured to reply to a received message, with a message having same subject line from the message sent by the first user, and
wherein the user communication device of the second user or at least a second user of the group of users is configured to:
receive any number of messages with different subject lines, and
reply to a received message, with a message having different subject line from the message sent by the first user.
